(19) United States
(12) Patent Application Publication
(10) Pub. No.: US 2019/0270441 A1
(43) Pub. Date: Sep. 5, 2019

(54) METHOD AND DEVICE FOR DETERMINING A VEHICLE DRIVING RESISTANCE

(71) Applicants: Hyundai Motor Company, Seoul (KR); Kia Motors Corporation, Seoul (KR)

(72) Inventor: Stefan HOFFMANN, Russelsheim (DE)

(73) Assignees: Hyundai Motor Company, Seoul (KR); Kia Motors Corporation, Seoul (KR)

(21) Appl. No.: 16/111,691

(22) Filed: Aug. 24, 2018

(30) Foreign Application Priority Data
Mar. 2, 2018 (DE) 102018203146.0

(51) Int. Cl. B60W 20/13; B60W 10/04

(52) U.S. Cl. CPC B60W 20/13; B60W 10/04; B60W 2720/40; B60W 2520/10; B60W 2510/244

(57) ABSTRACT

A method for determining a driving resistance of a target vehicle may include determining a vehicle deceleration of a reference vehicle, measuring a vehicle deceleration of a target vehicle, and determining a ratio thereof and providing a correction factor to normalize the determined ratio to a predetermined other starting velocity.

### CROSS-REFERENCE TO RELATED APPLICATION

The present application claims priority to DE-102018203146.0, filed on Mar. 2, 2018, the entire contents of which is incorporated herein for all purposes by this reference.

### BACKGROUND OF THE INVENTION

### Field of the Invention

The present invention relates to a method for determining a driving resistance of a target vehicle. The present invention further relates to a method for predictive modelling of a battery state of charge of a vehicle. The present invention moreover relates to a device, in particular an electronic control device, for determining a vehicle driving resistance. In addition, the present invention relates to a vehicle including the device configured for determining a vehicle driving resistance.

### Description of Related Art

A vehicle mass and frontal area can change significantly due to loading of the vehicle and for example trailer towing. To determine a driving resistance of the vehicle a number of variables may be known such as a rolling resistance coefficient, a vehicle mass, a vehicle frontal area, a vehicle speed, a gravity acceleration, a track coefficient, a gradient angle of a road surface and an air density.

While some of the above-mentioned variables may be obtained by vehicle sensors, other variables such as a frontal area, in the case of trailer towing, cannot easily be obtained. A change in frontal area of the vehicle however has a significant effect on the driving resistance and thus in turn for the case of a hybrid electric vehicle or a fully electric vehicle has a significant impact on predicting a battery state of charge, since an amount of electrical energy which may be recuperated by regenerative braking or an amount of electrical energy required for boosting significantly differs from a reference vehicle having a predetermined vehicle mass and frontal area.

US 2014/0297147 A1 includes a method for controlling regenerative braking in a hybrid motor vehicle with a regenerative braking system including determining the overall mass of the vehicle including passengers and cargo, determining changes in the mass of the vehicle due to changes in passengers or cargo, in the event of a change in the mass of the vehicle, adjusting the amount of braking force to be applied to the vehicle by the regenerative braking system in a response to a provided amount of brake pedal movement, wherein greater braking force is applied in a response to brake pedal movement if the mass of the vehicle has been determined to have increased, and less braking force is applied in a response to brake pedal movement if the mass of the vehicle has been determined to have decreased.

However, the above disclosure only takes the vehicle mass into account and not any change in frontal area of the vehicle.

There is consequently a need to further improve a method for determining a driving resistance to more accurately predict a battery state of charge of a hybrid electric vehicle or a fully electric vehicle.

The information disclosed in this Background of the Invention section is only for enhancement of understanding of the general background of the invention and may not be taken as an acknowledgement or any form of suggestion that this information forms the prior art already known to a person skilled in the art.

### BRIEF SUMMARY

Various aspects of the present invention are directed to providing a method for determining a driving resistance of a target vehicle. The present invention further relates to a method for predictive modelling of a battery state of charge of a vehicle, in particular a hybrid electric vehicle or an electric vehicle in accordance with claim 11. Moreover, various aspects of the present invention are directed to a device, in particular an electronic control device, for determining a driving resistance of a target vehicle in accordance with claim 13. Furthermore, various aspects of the present invention are directed a vehicle, in particular a hybrid electric vehicle or an electric vehicle in accordance with claim 14.

Various exemplary embodiments of the present invention are subject of the further sub-claims and of the following description, referring to the drawings.

Various aspects of the present invention are directed to a method for determining a driving resistance of a target vehicle. The method may include measuring a vehicle deceleration of the target vehicle from a starting velocity during the predetermined time interval induced by a driving resistance of the target vehicle.

The method may further include determining or providing a predetermined vehicle deceleration of a reference vehicle from the starting velocity during a predetermined time interval induced by a driving resistance of the reference vehicle.

The method moreover may include determining a ratio of the vehicle deceleration of the reference vehicle during the predetermined time interval and the vehicle deceleration of the target vehicle during the predetermined time interval.

The method additionally may include providing a predetermined correction factor to normalize the determined ratio to a predetermined other starting velocity.

Various aspects of the present invention are directed to a method for predictive modelling of a battery state of charge of a vehicle, in particular a hybrid electric vehicle or an electric vehicle. The method may include determining an amount of electrical energy which is recuperable by regenerative braking and/or the amount of electrical energy available for boosting on the basis of the driving resistance of the target vehicle determined by the method.

A further aspect of the present invention relates to a device, in particular an electronic control device configured for determining a driving resistance of a target vehicle, including measuring means configured to measure a vehicle deceleration of the target vehicle from a starting velocity during the predetermined time interval induced by a driving resistance of the target vehicle.

The device may further include determining means or providing means configured to determine or provide a predetermined vehicle deceleration of a reference vehicle from the starting velocity during a predetermined time interval induced by a driving resistance of the reference vehicle.

The device moreover may include determining means configured to determine a ratio of the vehicle deceleration of the reference vehicle during the predetermined time interval and the vehicle deceleration of the target vehicle during the predetermined time interval.

The device additionally may include providing means configured to provide a predetermined correction factor to normalize the determined ratio to a predetermined other starting velocity.

A further aspect of the present invention relates to a vehicle, in particular a hybrid electric vehicle or an electric vehicle, including a traction battery and a device, in particular an electronic control device, for determining a driving resistance of a target vehicle.

The idea of the present invention is directed to providing an enhanced method for determining a driving resistance of a target vehicle by comparing a vehicle deceleration of a reference vehicle with a vehicle deceleration of a target vehicle, i.e., the vehicle for which the driving resistance is to be determined as well as applying a correction factor to match the different starting velocities of the reference vehicle and the target vehicle.

By looking at a coasting behavior of the reference vehicle and the target vehicle changes of both vehicle mass and frontal area of the target vehicle in comparison to the reference vehicle may be observed. This also takes into account the case in which a trailer is towed by the target vehicle. By determining the driving resistance of the target vehicle, thus changes in the amount of recuperable energy compared to the reference vehicle may be determined which result from changes in mass and frontal area of the target vehicle.

Equally, changes in the amount of energy required during boosting with an electrical machine may be accurately determined when knowing the driving resistance of the target vehicle. Therefore, accurate predictive modelling of a battery state-of-charge (SOC) may be achieved with the method according to various aspects of the present invention by observing the vehicle coasting behavior of the target vehicle and then comparing it to the vehicle coasting behavior of a predetermined reference vehicle even without knowing variables such as the vehicle mass and frontal area which would normally be required to determine the driving resistance of the target vehicle.

The method according to various aspects of the present invention thus achieves an accurate determination of the driving resistance based on the coasting behavior of the target vehicle. Consequently, an optimum usage of available electrical energy of a traction battery of the hybrid electric vehicle or an electric vehicle is possible due to the possibility of enhanced predictive modelling of the battery state-of-charge of the traction battery.

According to various aspects of the present invention, the method may further include the step of determining a normalized ratio of the vehicle deceleration of the reference vehicle during the predetermined time interval and the vehicle deceleration of the target vehicle during the predetermined time interval by applying the predetermined correction factor to the previously determined ratio of the vehicle deceleration of the reference vehicle during the predetermined time interval and the vehicle deceleration of the target vehicle during the predetermined time interval.

By determining the normalized ratio of the vehicle decelerations of the reference vehicle and the target vehicle the starting velocity of the target vehicle may be matched to the predetermined other starting velocity since the different starting velocities would not allow a direct comparison of the coasting behavior of the reference vehicle to the coasting behavior of the target vehicle due to different air resistance of the target vehicle resulting from a lower or higher starting velocity compared to the starting velocity of the reference vehicle.

According to another exemplary embodiment of the present invention, the reference vehicle has a predetermined mass and frontal area, wherein the mass and frontal area of the target vehicle are derived by determining the driving resistance of the target vehicle. By observing and analyzing the vehicle behavior of the target vehicle under coasting conditions in comparison to the coasting behavior of the reference vehicle having a known vehicle mass and frontal area, the missing variables of the target vehicle, i.e., the vehicle mass and frontal area of the target vehicle can in the instant way be determined which allow for an accurate determination of the driving resistance of the target vehicle.

According to another exemplary embodiment of the present invention, the vehicle deceleration of the reference vehicle from the starting velocity during the predetermined time interval induced by the driving resistance of the reference vehicle is determined or provided based on a road inclination between −0.5° and +0.5°, preferably based on a road inclination of approximately 0° and wherein no braking and/or accelerating of the vehicle is performed. By measuring the vehicle deceleration of the reference vehicle under the above-mentioned parameters, an accurate determination of the vehicle coasting behavior of the reference vehicle may be obtained.

According to another exemplary embodiment of the present invention, a clutch and gear position of the target vehicle is determined, wherein if it is determined that the target vehicle is in-gear, an in-gear vehicle deceleration of the target vehicle from the starting velocity during the predetermined time interval induced by the driving resistance of the target vehicle is measured, and an in-gear vehicle deceleration of the reference vehicle from the starting velocity during the predetermined time interval induced by the driving resistance of the reference vehicle is determined or provided.

In the present way, the in-gear coasting behavior of the target vehicle is compared to the in-gear coasting behavior of the reference vehicle, wherein the determination of the in-gear coasting behavior of the reference vehicle can either be performed in advance and in turn be saved in a data storage or electronic control device of the vehicle or alternatively may be determined at the same time as the measurement of the coasting behavior of the target vehicle is performed.

According to another exemplary embodiment of the present invention, a currently selected gear of the target vehicle is determined, wherein the in-gear vehicle deceleration of the target vehicle from the starting velocity during the predetermined time interval induced by the driving resistance of the target vehicle for the currently selected gear is measured, and the in-gear vehicle deceleration for an identical gear of the reference vehicle from the starting velocity during the predetermined time interval induced by the driving resistance of the reference vehicle is determined or provided.

It is thus possible to compare the in-gear coasting behavior for a selected gear of the target vehicle to an in-gear coasting behavior of an identical gear of the reference vehicle thus facilitating an accurate comparison of the driving resistance of the target vehicle compared to the reference vehicle.

According to another exemplary embodiment of the present invention, a clutch and gear position of the target vehicle is determined, wherein if it is determined that the target vehicle is out-of-gear, an out-of-gear vehicle deceleration of the target vehicle from the starting velocity during the predetermined time interval induced by the driving resistance of the target vehicle is measured, and an out-of-gear vehicle deceleration of the reference vehicle from the starting velocity during the predetermined time interval induced by the driving resistance of the reference vehicle is determined or provided. Thus, an out-of-gear coasting behavior of the target vehicle may be reliably compared to an out-of-gear coasting behavior of the reference vehicle.

According to another exemplary embodiment of the present invention, the starting velocity of the reference vehicle is above 20 km/h, preferably between 50 km/h and 150 km/h, in particular preferably 100 km/h. A meaningful analysis of the coasting behavior of the target vehicle can thus advantageously be performed for velocities of above 20 km/h, wherein it is preferable to choose a medium velocity of 100 km/h as the starting velocity of the reference vehicle to which the starting velocity of the target vehicle can then be matched.

According to another exemplary embodiment of the present invention, the predetermined time interval is between 5 and 20 seconds, preferably 5 seconds. The time interval of 5 seconds is sufficient to accurately determine the coasting behavior of a vehicle.

According to another exemplary embodiment of the present invention, the vehicle deceleration of the target vehicle from the starting velocity during the predetermined time interval induced by the driving resistance of the target vehicle is measured at predetermined time intervals or at predetermined deceleration cycles, wherein a moving average of the normalized ratio of the vehicle deceleration of the reference vehicle during the predetermined time interval and the vehicle deceleration of the target vehicle during the predetermined time interval is determined.

By performing determinations of the vehicle deceleration of the target vehicle at the predetermined time intervals, the moving average of the normalized ratio can thus be determined, thus resulting in a more accurate determination of the coasting behavior of the target vehicle due to multiple measurements of the vehicle deceleration of the target vehicle at different starting velocities.

According to another exemplary embodiment of the present invention, a recuperation or boosting request is generated on the basis of the driving resistance of the target vehicle. By knowing the deceleration by observing the coasting behavior of the target vehicle, it is possible to determine the vehicle mass and frontal area of the target vehicle, thus being able to predict the battery state of charge of the hybrid electric vehicle or the electric vehicle which in turn makes it possible to generate a recuperation or boosting request by the device, in particular the electronic control device.

The herein described features of the method for determining a driving resistance of a target vehicle and of a device, in particular the electronic control device, for determining the driving resistance of the target vehicle included in the context of use for a vehicle, in particular a hybrid electric vehicle or an electric vehicle. Alternatively, the method and device can also be used for alternative applications, e.g., any kind of moving vehicle having a traction battery in which it is desirable to determine a battery state of charge to enable to more accurately model recuperation or boosting requests. Such applications may include electric or hybrid electric motorbikes, bicycles, ships and/or airplanes.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 shows a flowchart of a method for determining a driving resistance of a target vehicle according to an exemplary embodiment of the present invention;

FIG. 2 shows a graph indicating a vehicle deceleration of a reference vehicle, a vehicle deceleration of a target vehicle, a ratio of the vehicle deceleration of the reference vehicle and the target vehicle, a normalized velocity ratio to a specific starting velocity and an accelerator pedal position of the vehicle;

FIG. 3 shows a graph indicating a coasting behavior of a vehicle for different load and frontal area conditions for a starting velocity of the vehicle;

FIG. 4 shows a graph indicating a coasting behavior of a vehicle for different load and frontal area conditions for a starting velocity of the vehicle;

FIG. 5 shows a graph indicating a coasting behavior of a vehicle for different load and frontal area conditions for a third starting velocity of the vehicle;

FIG. 6 shows a flowchart of a complete method for determining the driving resistance of the target vehicle according to the exemplary embodiment of the present invention;

FIG. 7 shows a method for predictive modelling of a battery state of charge of the vehicle according to the exemplary embodiment of the present invention;

FIG. 8 shows a device configured for determining the driving resistance of the target vehicle; and

FIG. 9 shows a vehicle including the device according to the exemplary embodiment of the present invention.

Unless indicated otherwise, like reference numerals or signs to the figures indicate like elements.

It may be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particularly intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the other hand, the invention(s) is/are intended to cover not only the exemplary embodiments, but also various alternatives, modifications, equivalents and other embodiments, which may be included within the spirit and scope of the invention as defined by the appended claims.

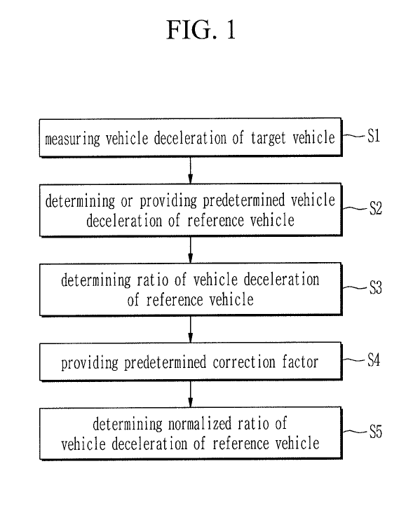

FIG. 1 shows a flowchart of a method for determining a driving resistance of a target vehicle according to an exemplary embodiment of the present invention.

The method includes the step S1 of measuring a vehicle deceleration of the target vehicle from a starting velocity during the predetermined time interval induced by a driving resistance of the target vehicle.

The method further includes the step S2 determining or providing a predetermined vehicle deceleration of a reference vehicle from the starting velocity during a predetermined time interval induced by a driving resistance of the reference vehicle.

The method moreover includes the step S3 of determining a ratio of the vehicle deceleration of the reference vehicle during the predetermined time interval and the vehicle deceleration of the target vehicle during the predetermined time interval.

The method includes furthermore the step S4 of providing a predetermined correction factor to normalize the determined ratio to a predetermined other starting velocity.

The method additionally includes the step S5 of determining a normalized ratio of the vehicle deceleration of the reference vehicle during the predetermined time interval and the vehicle deceleration of the target vehicle during the predetermined time interval by applying the predetermined correction factor to the previously determined ratio of the vehicle deceleration of the reference vehicle during the predetermined time interval and the vehicle deceleration of the target vehicle during the predetermined time interval.

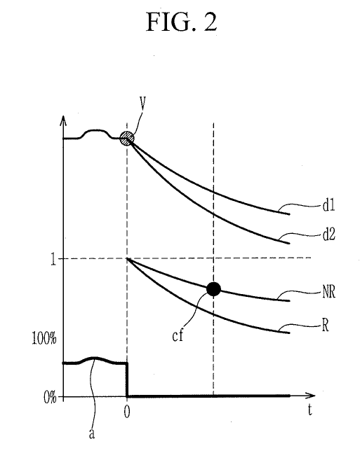

FIG. 2 shows a graph indicating a vehicle deceleration of a reference vehicle, a vehicle deceleration of a target vehicle, a ratio of the vehicle deceleration of the reference vehicle and the target vehicle, a normalized velocity ratio to a predetermined other starting velocity and an accelerator pedal position of the vehicle.

Curve d1 shows the vehicle deceleration, also known as the vehicle coast down of the reference vehicle from a starting velocity V for a predetermined time interval induced by a driving resistance of the reference vehicle.

Curve d2 shows a measured vehicle deceleration, also known as a measured vehicle coast down of the target vehicle from the starting velocity V. The vehicle deceleration of the target vehicle is measured for a predetermined time interval induced by a driving resistance of the target vehicle.

The curve R shows a ratio of the vehicle deceleration of the reference vehicle during the predetermined time interval and the vehicle deceleration of the target vehicle during the predetermined time interval.

The curve NR shows a normalized ratio of the vehicle deceleration of the reference vehicle during the predetermined interval and the vehicle deceleration of the target vehicle during the predetermined time interval by applying a predetermined correction factor to normalize the determined ratio to a predetermined other starting velocity (VO).

Furthermore, the curve a shows a position of an accelerator pedal of the vehicle, wherein the vehicle deceleration or coast down of the reference vehicle and the target vehicle begin upon a state in which the accelerator pedal of the vehicle is not pressed, i.e. is at the 0% position indicated by curve a.

Cf represents a point on curve NR which is a specific correction factor cf to normalize the determined ratio to the predetermined other starting velocity VO.

In an exemplary embodiment of the present invention, the driving resistance of the target vehicle at predetermined other starting velocity VO can be calculated based on the determined ratio.

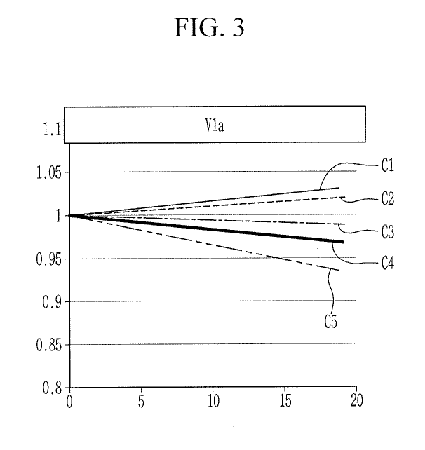

FIG. 3 shows a graph indicating a coasting behavior of a vehicle for different load and frontal area conditions for a starting velocity of the vehicle.

The starting velocity V1a, which is 50 km/h, of the target vehicle is shown for different cases of the vehicle load and frontal area on the vertical axis of the graph, which ranges from 0.8 to 1.1, the ratio of the vehicle deceleration of the target vehicle during the predetermined time interval and the vehicle deceleration of the target vehicle during the predetermined time interval, i.e., the ratio of curve d2 to curve d1 shown in FIG. 2, which is the ratio of the measured vehicle coast down to the target vehicle coast down. The horizontal axis of the graph shows time indicated in seconds.

Line c1 represents the target vehicle carrying an additional load of 1000 kg. Line c2 represents the target vehicle carrying an additional load of 500 kg. Line c3 shows the target vehicle carrying an additional load of 1000 kg and having a frontal area of 4 m².

Line c4 represents the target vehicle carrying an additional load of 500 kg and furthermore having a frontal area of 4 m². Line c5 represents the target vehicle with no additional load and having a frontal area of 4 m².

The horizontal line at the ratio of 1 on the vertical axis represents the coast down behavior of the reference vehicle which is defined as a vehicle carrying no additional load and having a frontal area of 2 m², wherein a basic mass of the reference vehicle and the target vehicle is identical.

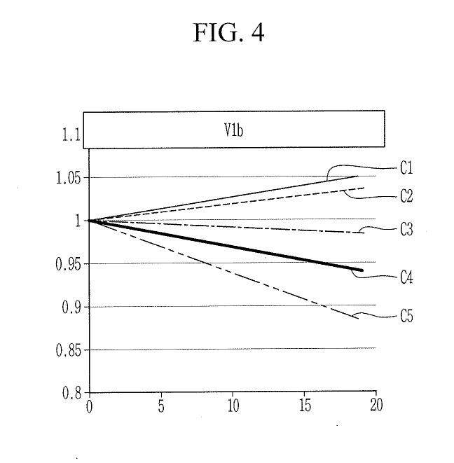

FIG. 4 shows a graph indicating a coasting behavior of a vehicle for different load and frontal area conditions for a starting velocity of the vehicle.

Line cl represents the target vehicle carrying an additional load of 1000 kg. Line c2 represents the target vehicle carrying an additional load of 500 kg. Line c3 shows the target vehicle carrying an additional load of 1000 kg and having a frontal area of 4 m².

Line c4 represents the target vehicle carrying an additional load of 500 kg and furthermore having a frontal area of 4 m². Line c5 represents the target vehicle with no additional load and having a frontal area of 4 m².

The starting velocity V1b of the target vehicle in FIG. 4 is 100 km/h.

As can clearly be seen in FIG. 4, compared to the lower starting velocity of 50 km/h of FIG. 3, the different depicted ratios differ from each other because e.g., line c5 in FIG. 4 shows a sharper deceleration compared to line c5 in FIG. 3 due to the higher starting velocity in FIG. 4 and thus, the vehicle having a frontal area of 4 m² due to the fact that a trailer is towed by the vehicle thus results in the sharper deceleration of the target vehicle in FIG. 4.

On the other end portion of the spectrum, looking at e.g., line c1 in FIG. 4 which shows the target vehicle with an additional load of 1000 kg, the deceleration of the target vehicle is slower in FIG. 4 compared to the lower starting velocity in FIG. 3 due to the higher inertia of the target vehicle having the additional load of 1000 kg.

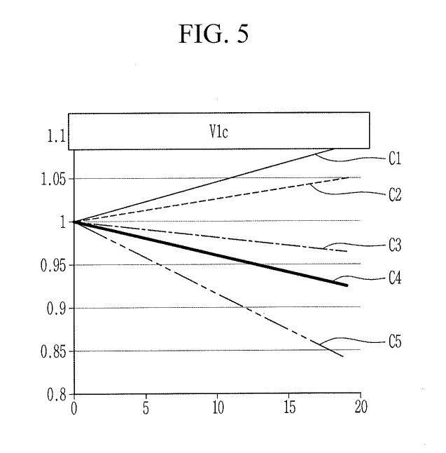

FIG. 5 shows a graph indicating a coasting behavior of a vehicle for different load and frontal area conditions for a third starting velocity of the vehicle.

Like in FIG. 3 and FIG. 4, in FIG. 5 line c1 represents the target vehicle carrying an additional load of 1000 kg. Line c2 represents the target vehicle carrying an additional load of 500 kg. Line c3 shows the target vehicle carrying an additional load of 1000 kg and having a frontal area of 4 m².

Line c4 represents the target vehicle carrying an additional load of 500 kg and furthermore having a frontal area of 4 m². Line c5 represents the target vehicle with no additional load and having a frontal area of 4 m².

According to FIG. 5, the starting velocity V1c of the target vehicle is set to 150 km/h. What may be observed in FIG. 5 is that compared to FIG. 3 and FIG. 4 due to the even higher starting velocity of the target vehicle, line c5 for example shows an even sharper drop which represents a sharper decrease in velocity, i.e. a sharper vehicle deceleration of the target vehicle due to increased air resistance.

On the other hand, line c1 which represents the target vehicle having an additional load of 1000 kg shows a higher ratio which indicates less of a deceleration of the target vehicle compared to the reference vehicle having no additional load. This is due to the higher inertia of the target vehicle due to the high additional load of 1000 kg.

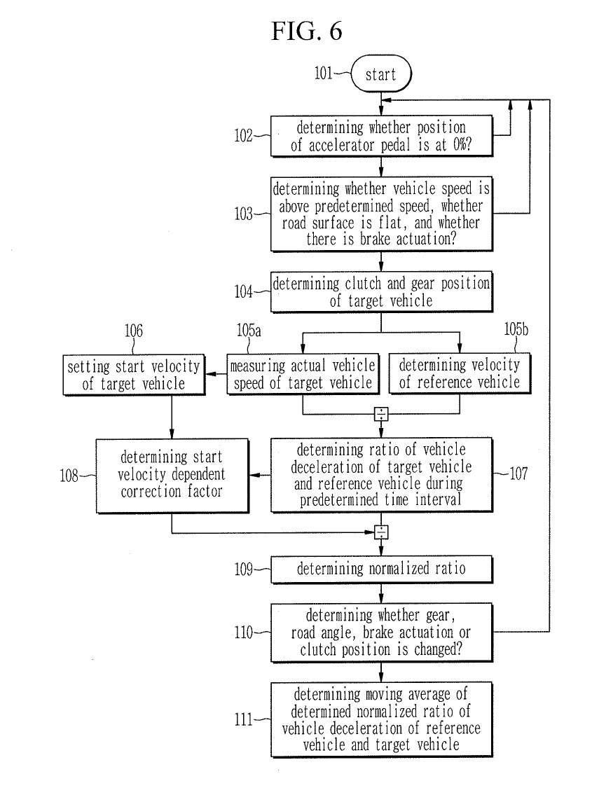

FIG. 6 shows a flowchart of a complete method for determining the driving resistance of the target vehicle according to the exemplary embodiment of the present invention.

In step 101, the method for determining the driving resistance of the target vehicle begins. At step 102, it is determined if a position of the accelerator pedal is at 0%, i.e. If an accelerator pedal value is reduced from x% to 0%. If this is the case the method proceeds to step 103, if not the method returns to step 101.

At step 103, a determination is made if the vehicle speed is above a predetermined speed, preferably 20 km/h, if an inclination of the road surface is between −0.5° and +0.5°, i.e., the road surface is substantially flat and it is determined whether or not there is a brake actuation. If there is no brake actuation and the other two afore-mentioned questions are also answered positively the method proceeds to step 104, if not it returns to step 101.

In step 104, a clutch and gear position of the target vehicle is determined. Subsequently, the method proceeds to steps 105a and 105b which are performed in parallel. In step 105a, an actual vehicle speed of the target vehicle is measured, and in step 105b, a velocity determination of a reference vehicle based on an actual gear and clutch position of the target vehicle is started. Alternatively, the present determination may be performed before and the result of which may be provided. In step 106 which follows step 105a, the velocity at a time step “0” is set to start velocity of the target vehicle.

The method then proceeds to step 108 in which a start velocity dependent correction factor is determined for normalizing the start velocity of the target vehicle to a predetermined other starting velocity.

At step 107 which follows steps 105a and 105b, a ratio of the vehicle deceleration of the target vehicle and the reference vehicle during the predetermined time interval is determined. After this determination has been made, the method proceeds from step 107 to step 108 previously explained.

From step 108, the method proceeds to step 109, wherein the method performs determination of the normalized ratio using the ratio determined in step 107 and applying to it the normalization factor determined as step 108.

Subsequently, the method proceeds to step 110 in which it is determined if there is a change in gear, road angle, brake actuation or clutch position. If not the method proceeds to step 111, if yes the method returns to step 101. In method step 111, a moving average of the determined normalized ratio of the vehicle deceleration of the reference vehicle and the target vehicle is determined at certain time intervals or at certain cycles, e.g., at time intervals of 5 seconds.

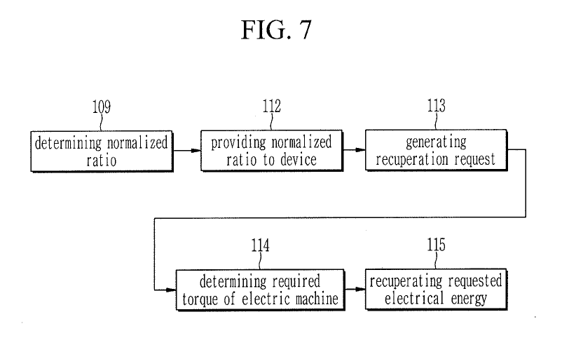

FIG. 7 shows a method for predictive modelling of a battery state of charge of the vehicle according to the exemplary embodiment of the present invention.

In step 109 as explained with reference to FIG. 6, the normalized ratio of the vehicle deceleration of the reference vehicle and the target vehicle is determined. In step 112, a device such as an electronic control device of the vehicle or in the case of a hybrid electric vehicle a hybrid controller is provided with the normalized ratio determined in step 109. In step 113, the device is thus configured for generating a recuperation request which is then implemented in step 114 in which a required torque of the electric machine is determined. In step 115, the electric machine recuperates the requested electrical energy.

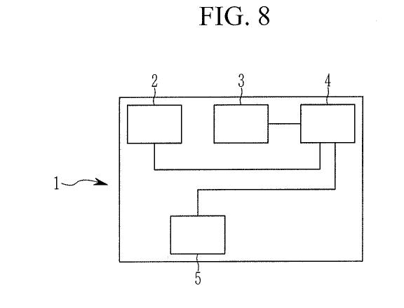

FIG. 8 shows a device configured for determining the driving resistance of the target vehicle.

The device 1, in particular an electronic control device configured for determining a driving resistance of a target vehicle, includes determining means 2 or providing means, configured to determine or provide a predetermined vehicle deceleration of a reference vehicle from a starting velocity during a predetermined time interval induced by a driving resistance of the reference vehicle.

The device 1 further includes measuring means 3 configured to measure a vehicle deceleration of the target vehicle from a starting velocity during the predetermined time interval induced by a driving resistance of the target vehicle.

The device 1 additionally includes determining means 4 configured to determine a ratio of the vehicle deceleration of the reference vehicle during the predetermined time interval and the vehicle deceleration of the target vehicle during the predetermined time interval. The device 1 furthermore includes providing means 5 configured to provide a predetermined correction factor to normalize the determined ratio to the predetermined other starting velocity.

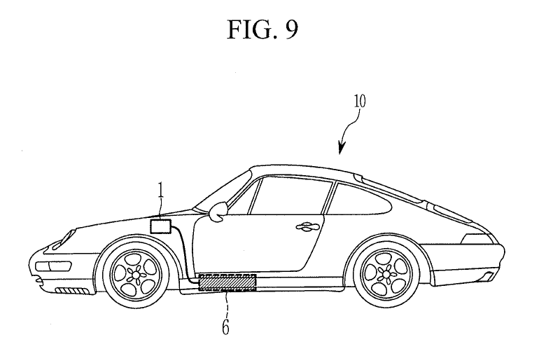

FIG. 9 shows a vehicle including the device according to the exemplary embodiment of the present invention.

The vehicle 10 includes a traction battery 6 and the device 1 described with reference to FIG. 8, the device 1 being electrically connected to the traction battery 6. An electric machine of the vehicle 10 is not depicted in FIG. 9.

Although specific embodiments have been illustrated and described herein, it will be appreciated by those of ordinary skill in the art that a variety of alternative and/or equivalent implementations exist.

It may be appreciated that the exemplary embodiment or exemplary embodiments are only examples, and are not intended to limit the scope, applicability, or configuration.

Rather, the foregoing BRIEF SUMMARY and detailed description will provide those skilled in the art with a convenient road map for implementing at least an exemplary embodiment of the present invention, it being understood that various changes may be made in the function and arrangement of elements described in an exemplary embodiment without departing from the scope as set forth in the appended claims and their legal equivalents.

The present invention is directed to cover any adaptations or variations of the specific embodiments discussed herein.

For convenience in explanation and accurate definition in the appended claims, the terms “upper”, “lower”, “inner”, “outer”, “up”, “down”, “upper”, “lower”, “upwards”, “downwards”, “front”, “rear”, “back”, “inside”, “outside”, “inwardly”, “outwardly”, “internal”, “external”, “inner”, “outer”, “forwards”, and “backwards” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described to explain certain principles of the invention and their practical application, to enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A method for determining a driving resistance of a target vehicle, comprising:
measuring, by a controller, a vehicle deceleration of the target vehicle from a starting velocity thereof during a predetermined time interval, the vehicle deceleration induced by the driving resistance of the target vehicle;
determining or providing, by the controller, a vehicle deceleration of a reference vehicle from the starting velocity during the predetermined time interval, the predetermined vehicle deceleration induced by a driving resistance of the reference vehicle;
determining, by the controller, a ratio of the vehicle deceleration of the reference vehicle during the predetermined time interval and the vehicle deceleration of the target vehicle during the predetermined time interval; and
providing, by the controller, a predetermined correction factor to normalize the determined ratio to a predetermined other starting velocity.

2. The method according to claim 1, further including:
determining a normalized ratio of the vehicle deceleration of the reference vehicle during the predetermined time interval and the vehicle deceleration of the target vehicle during the predetermined time interval by applying the predetermined correction factor to a previously determined ratio of the vehicle deceleration of the reference vehicle during the predetermined time interval and the vehicle deceleration of the target vehicle during the predetermined time interval.

3. The method according to claim 1, wherein a mass amount and a frontal area of the target vehicle are derived by determining the driving resistance of the target vehicle.

4. The method according to claim 1, wherein the vehicle deceleration of the reference vehicle from the starting velocity during the predetermined time interval induced by the driving resistance of the reference vehicle is determined or provided based on a road inclination between −0.5° and +0.5° when no braking or accelerating of the vehicle is performed.

5. The method according to claim 1,
wherein a clutch and a gear position of the target vehicle are determined, and
wherein, when it is determined, based on the clutch and the gear position of the target vehicle, that the target vehicle is in-gear, an in-gear vehicle deceleration of the target vehicle from the starting velocity during the predetermined time interval induced by the driving resistance of the target vehicle is determined, and an in-gear vehicle deceleration of the reference vehicle from the starting velocity during the predetermined time interval induced by the driving resistance of the reference vehicle is determined or provided.

6. The method according to claim 5,
wherein a currently selected gear of the target vehicle is determined, and
wherein the in-gear vehicle deceleration of the target vehicle from the starting velocity during the predetermined time interval induced by the driving resistance of the target vehicle for the currently selected gear is determined, and the in-gear vehicle deceleration for an identical gear of the reference vehicle from the starting velocity during the predetermined time interval induced by the driving resistance of the reference vehicle is determined or provided.

7. The method according to claim 1,
wherein a clutch and a gear position of the target vehicle is determined, and
wherein, when it is determined, based on the clutch and the gear position of the target vehicle that the target vehicle is out-of-gear, an out-of-gear vehicle deceleration of the target vehicle from the starting velocity during the predetermined time interval induced by the driving resistance of the target vehicle is determined, and an out-of-gear vehicle deceleration of the reference vehicle from the starting velocity during the predetermined time interval induced by the driving resistance of the reference vehicle is determined or provided.

8. The method according to claim 1, wherein the starting velocity of the reference vehicle is between 50 km/h and 150 km/h.

9. The method according to claim 1, wherein the predetermined time interval is between 5 and 20 seconds.

10. The method according to claim 1,
wherein the vehicle deceleration of the target vehicle from the starting velocity during the predetermined time interval induced by the driving resistance of the target vehicle is determined at predetermined time intervals or at predetermined deceleration cycles, and
wherein a moving average of the normalized ratio of the vehicle deceleration of the reference vehicle during the predetermined time intervals and the vehicle deceleration of the target vehicle during the predetermined time intervals is determined.

11. A method for predictive modelling of a battery state of charge of a vehicle, comprising:
determining an amount of electrical energy which is recuperable by regenerative braking or an amount of electrical energy available for boosting on a basis of a driving resistance of the target vehicle determined by the method according to claim 1.

12. The method according to claim 11, wherein a recuperation or boosting request is generated on a basis of the driving resistance of the target vehicle.

13. A controller of determining a driving resistance of a target vehicle, the controller including:
a measuring device configured to determine a vehicle deceleration of the target vehicle from a starting velocity during a predetermined time interval induced by the driving resistance of the target vehicle;
a determining device or providing device configured to determine or provide a predetermined vehicle deceleration of a reference vehicle from the starting velocity during the predetermined time interval induced by a driving resistance of the reference vehicle;
a determining device configured to determine a ratio of the vehicle deceleration of the reference vehicle during the predetermined time interval and the vehicle deceleration of the target vehicle during the, predetermined time interval; and
a providing device configured to provide a predetermined correction factor to normalize the determined ratio to a predetermined other starting velocity .

14. A vehicle including a traction battery and an electronic controller, for determining the driving resistance of the target vehicle according to claim 13.
